(19) United States
(12) Patent Application Publication
(10) Pub. No.: US 2026/0155697 A1
(43) Pub. Date: Jun. 4, 2026

(54) ENCASED ARMATURE OF LINEAR MOTOR

(71) Applicant: FANUC CORPORATION, Minamitsuru-gun, Yamanashi (JP)

(72) Inventors: Hiroki MATSUNAKA, Yamanashi (JP); Yuusuke KONDOU, Yamanashi (JP)

(73) Assignee: FANUC CORPORATION, Minamitsuru-gun, Yamanashi (JP)

(21) Appl. No.: 19/122,879

(22) PCT Filed: Dec. 5, 2022
(86) PCT No.: PCT/JP2022/044734

§ 371 Date: Apr. 21, 2025

(51) Int. Cl. H02K 5/04; H02K 3/04

(52) U.S. Cl. CPC H02K 5/04; H02K 3/04

(57) ABSTRACT

An encased armature of the present disclosure comprises: an armature having a core constituting a body, a coil provided to the core, and a resin part covering some or all of the core and the coil; and a case in which the armature can be housed. The case has a cylindrical case body covering the outside of the armature; a first lid portion that closes an opening on one end in the axial direction of the case body; a first elastic body that seals a gap between the case body and the first lid portion and that attaches the first lid portion to the case body; a second lid portion that closes an opening on the other end in the axial direction of the case body; and a second elastic body that seals a gap between the case body and the second lid portion and that attaches the second lid portion to the case body.

### TECHNICAL FIELD

The present disclosure relates to an encased armature of a linear motor.

### BACKGROUND ART

In recent years, it has been proposed to use a linear motor as a driving device for various industrial machines, such as a magnetic head driving mechanism of an office automation apparatus, a spindle or a table feeding mechanism of a machine tool, and the like. In this type of linear motor, an armature is used in combination with a magnet plate that functions as a field magnetic pole. Known armatures include a type in which a resin molded onto a core and a coil is exposed and a type in which a core, a coil, and a resin molded onto the core and the coil are housed in a case.

A linear motor is often incorporated in machines that perform machining using a cutting fluid, such as metalworking. For this reason, the linear motor is provided with the armature of the latter type mentioned above, in consideration of dustproofness and waterproofness. The case of the armature of the latter type is assembled into a box shape by using screws or by welding.

### Citation List

### Patent Document

Patent Document 1: Japanese Unexamined Patent Application, Publication No. 2019-115171

### DISCLOSURE OF THE INVENTION

### Problems to be Solved by the Invention

When the case is assembled by welding, the components constituting the case are welded to each other. Specifically, when the case has an upper wall, a lower wall, a left wall, a right wall, a front wall, and a rear wall, it is necessary to weld the walls individually. Therefore, when assembling the case by welding, many portions need to be welded. Such assembly in which many portions are welded not only requires time and effort to perform the welding operation, but also may increase the possibility of occurrence of a welding defect.

In order to overcome the disadvantages described above, there is a demand for an encased armature whose case has a reduced number of welded portions.

### Means for Solving the Problems

An encased armature according to the present disclosure includes: an armature including a core as a main body, a coil provided to the core, a resin portion partially or fully covering the core and the coil; and a case capable of housing the armature therein. The case includes a case main body that has a tubular shape and covers an outer side of the armature, a first lid that closes an opening at one axial end of the case main body, a first elastic body that seals a gap between the case main body and the first lid and allows the first lid to be attached to the case main body, a second lid that closes an opening at an other axial end of the case main body, and a second elastic body that seals a gap between the case main body and the second lid and allows the second lid to be attached to the case main body.

### BRIEF DESCRIPTION OF THE DRAWINGS

FIG. 1 is a perspective view illustrating an encased armature according to a first embodiment of the present invention;

FIG. 2 is an exploded perspective view of the encased armature according to the first embodiment of the present invention, and illustrates a state in which some parts of the armature are pulled out from the case for ease of understanding;

FIG. 3 is a perspective view illustrating a first lid of the encased armature according to the first embodiment of the present invention, when viewed from the inside of the case;

FIG. 4 is an exploded perspective view of an encased armature according to a second embodiment of the present invention, and illustrates a state in which some parts of the armature are pulled out from the case;

FIG. 5 is an exploded perspective view of an encased armature according to a third embodiment of the present invention, and illustrates a state in which some parts of the armature are pulled out from the case; and

FIG. 6 is an exploded perspective view of an encased armature according to a fourth embodiment of the present invention, and illustrates a state in which some parts of the armature are pulled out from the case.

### PREFERRED MODE FOR CARRYING OUT THE INVENTION

An encased armature according to one aspect of the present disclosure will be described with reference to the drawings.

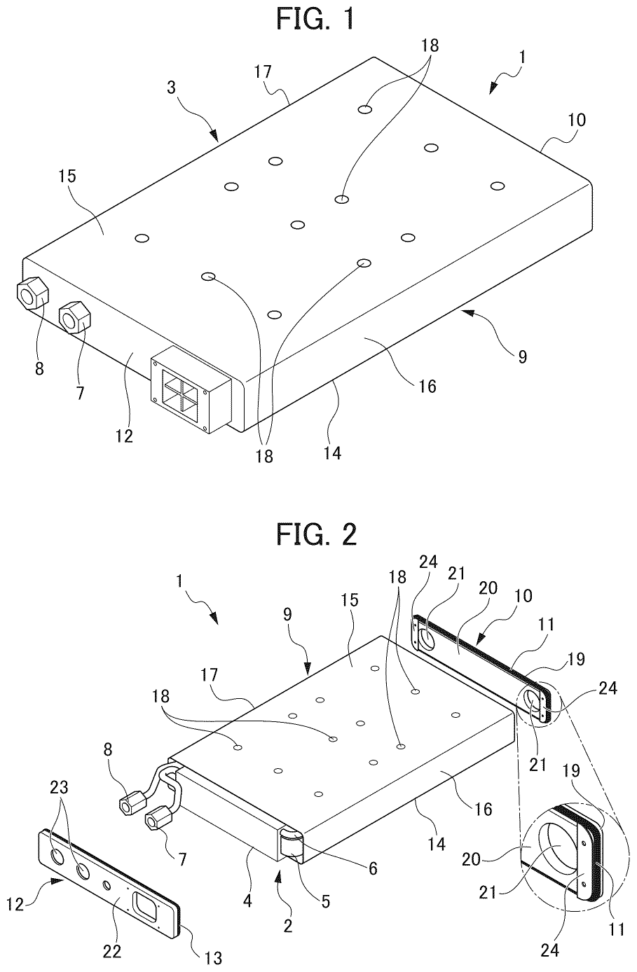

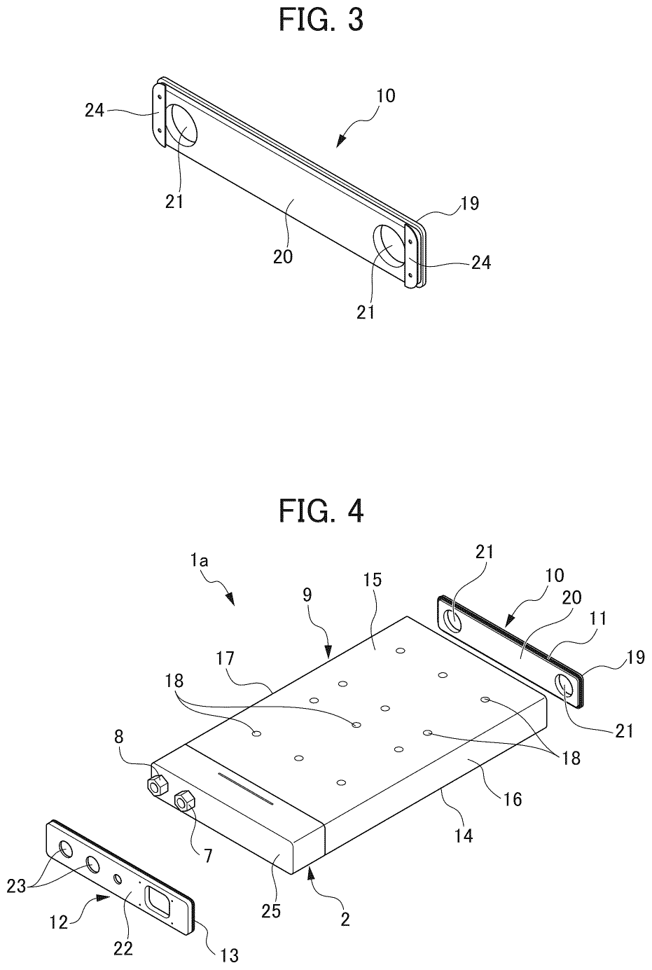

An encased armature 1 according to a first embodiment will be described with reference to FIGS. 1 to 3. The encased armature 1 is a constituent element of a linear motor, and generates a driving force for linear motion in cooperation with a magnet plate that is used as a field magnetic pole of the linear motor. The encased armature 1 of the present embodiment includes an armature 2 and a case 3.

The armature 2 has a known configuration. Typically, the armature 2 includes a core 4, a coil 5, and a resin portion (not shown). The core 4 is a member serving as a main body of the armature 2. The core 4 has a substantially block shape and is made of a magnetic material. The coil 5 is a wire that generates a magnetic field. The coil 5 is provided to the core 4. Specifically, the coil 5 is wound around a slot (not shown) formed in the core 4. The coil 5 is supplied with AC power from a power supply (not shown). The resin portion is provided so as to partially or fully cover the core 4 and the coil 5. In other words, the resin portion is molded onto the core 4 provided with the coil 5. The molding of the resin portion will be described later.

In the illustrated example, the armature 2 includes a refrigerant pipe 6 through which a refrigerant for cooling the coil 5 passes. The refrigerant pipe 6 is a meandering pipe. The refrigerant pipe 6 has, at one end thereof, an inlet 7 through which the refrigerant is introduced into the refrigerant pipe 6. The other end of the refrigerant pipe 6 is provided with an outlet 8 through which the refrigerant is discharged from the refrigerant pipe 6. In the configuration in which the armature 2 includes the refrigerant pipe 6, the refrigerant pipe 6 is covered with the resin portion except for the one end and the other end.

The case 3 is hollow and can house the armature 2 therein. The case 3 includes a case main body 9, a first lid 10, a first elastic body 11, a second lid 12, and a second elastic body 13.

The case main body 9 is a member that covers the outer side of the armature 2. The case main body 9 has a tubular shape whose opposite axial ends are open. In the present embodiment, the case main body 9 has a prismatic tubular shape. Typically, the case main body 9 has a quadrangular tubular shape having a first wall 14, a second wall 15, a third wall 16, and a fourth wall 17.

The first wall 14 faces the magnet plate used as a field magnetic pole of the linear motor. The second wall 15 is at a position facing (opposite to) the first wall 14. The second wall 15 has a plurality of through holes 18 through which screws pass when the encased armature 1 is attached to an object (a machine, a unit, a member, etc.) to be driven. In the case of attaching the encased armature 1 to the object to be driven, the screws are threaded into screw holes formed in the armature 2 via the through holes 18. In the present embodiment, the first wall 14 and the second wall 15 face each other in a thickness direction of the case 3. One end of the first wall 14 and one end of the second wall 15 are connected to each other with the third wall 16. The other end of the first wall 14 and the other end of the second wall 15 are connected to each other with the fourth wall 17. In the present embodiment, the third wall 16 and the fourth wall 17 face each other in a width direction of the case 3.

Corner portions of the case main body 9 are R-shaped. Specifically, the corner portion between the first wall 14 and the third wall 16, the corner portion between the first wall 14 and the fourth wall 17, the corner portion between the second wall 15 and the third wall 16, and the corner portion between the second wall 15 and the fourth wall 17 are R-shaped. The term “R-shaped” as used herein means that a corner portion has a rounded shape by being formed into an arc shape.

The first lid 10 is a plate-shaped member that closes an opening at one axial end (on an upper right side in FIG. 2) of the case main body 9. In the present embodiment, the first lid 10 includes a first lid main body 19 and a first insertion portion 20. The first lid main body 19 closes the opening at the one axial end of the case main body 9. The first lid main body 19 has a substantially quadrangular plate shape and is disposed with its plate surface facing in the axial direction of the case main body 9. The first insertion portion 20 is insertable into the opening at the one axial end of the case main body 9. The first insertion portion 20 has a substantially quadrangular plate shape and is provided on a central portion of the plate surface of the first lid main body 19. The first insertion portion 20 protrudes from the first lid main body 19 toward the other axial end of the case main body 9. The first insertion portion 20 provided on the first lid main body 19 has its plate surface facing in the axial direction of the case main body 9. The outer shape of the first insertion portion 20 is smaller than the outer shape of the first lid main body 19, whereby the first lid 10 has a step portion recessed inward. The step portion of the first lid 10 constitutes the outer peripheral surface of the first insertion portion 20.

The first lid 10 has an injection port 21 through which a resin for forming the resin portion that covers the core 4, the coil 5, and the refrigerant pipe 6 is injected into the case 3. The injection port 21 penetrates the first lid 10 in a thickness direction. That is, the injection port 21 penetrates the first lid main body 19 in the thickness direction and penetrates the first insertion portion 20 in the thickness direction. In the present embodiment, the first lid 10 has two injection ports 21, 21. One of the two injection ports 21, 21 is for actually injecting the resin. The other of the two injection ports 21, 21 is for releasing air from the case 3 to the outside during injection of the resin into the case 3. In the present embodiment, the first lid 10 has the injection ports 21, but the second lid 12, which will be described later, may have injection ports, instead of the first lid 10. The number of injection ports 21 is not limited to two.

The first elastic body 11 is an elastically deformable annular member. Typically, the first elastic body 11 is an O-ring. The first elastic body 11 is externally fitted on the first insertion portion 20 of the first lid 10 so that the first elastic body 11 is disposed on the above-described step portion of the first lid 10.

The first lid 10 having the first elastic body 11 fitted thereon is attached to the case main body 9 so as to close the opening at the one axial end of the case main body 9. Specifically, the first insertion portion 20 is inserted into the opening at the one axial end of the case main body 9 until the first lid main body 19 comes into contact with the one axial end of the case main body 9. In a state in which the first insertion portion 20 is inserted in the case main body 9, the first elastic body 11 is positioned between the case main body 9 and the first insertion portion 20 while being deformed and crushed. Accordingly, the first lid 10 is attached to the case main body 9 by friction between the first elastic body 11 and the case main body 9. In a state in which the first lid 10 is attached to the case main body 9, the first elastic body 11 seals a gap between the first insertion portion 20 and the case main body 9. Thus, the first elastic body 11 is a member that seals the gap between the case main body 9 and the first lid 10 and that allows the first lid 10 to be attached to the case main body 9.

The second lid 12 is a plate-shaped member that closes the opening at the other axial end of the case main body 9. In the present embodiment, the second lid 12 has basically the same configuration as the first lid 10. Specifically, the second lid 12 includes a second lid main body 22 and a second insertion portion (not shown). The second lid main body 22 closes the opening at the other axial end the case main body 9. The second lid main body 22 has a substantially quadrangular plate shape and is disposed with its plate surface facing in the axial direction of the case main body 9. The second insertion portion is insertable into the opening at the other axial end of the case main body 9. The second insertion portion has a substantially quadrangular plate shape and is provided on a central portion of the plate surface of the second lid main body 22. The second insertion portion protrudes from the second lid main body 22 toward the one axial end of the case main body 9. The second insertion portion provided on the second lid main body 22 has its plate surface facing in the axial direction of the case main body 9. The outer shape of the second insertion portion is smaller than the outer shape of the second lid main body 22, whereby the second lid 12 has a step portion recessed inward. The step portion of the second lid 12 constitutes the outer peripheral surface of the second insertion portion. In the illustrated example, the second lid 12 has through holes 23 through which the inlet 7 and the outlet 8 of the refrigerant pipe 6 pass, etc.

The second elastic body 13 is an elastically deformable annular member. Typically, the second elastic body 13 is an O-ring. The second elastic body 13 is externally fitted on the second insertion portion of the second lid 12 so that the second elastic body 13 is disposed on the above-described step portion of the second lid 12.

The second lid 12 having the second elastic body 13 fitted thereon is attached to the case main body 9 so as to close the opening at the other axial end of the case main body 9. The second lid 12 is attached to the case main body 9 in the same manner as the first lid 10. Specifically, the second insertion portion is inserted into the opening at the other axial end of the case main body 9 until the second lid main body 22 comes into contact with the other axial end of the case main body 9. In a state in which the second insertion portion is inserted into the case main body 9, the second elastic body 13 is positioned between the case main body 9 and the second insertion portion while being deformed and crushed.

Accordingly, the second lid 12 is attached to the case main body 9 by friction between the second elastic body 13 and the case main body 9. In a state in which the second lid 12 is attached to the case main body 9, the second elastic body 13 seals a gap between the second insertion portion and the case main body 9. Thus, the second elastic body 13 is a member that seals the gap between the case main body 9 and the second lid 12 and that allows the second lid 12 to be attached to the case main body 9.

In the present embodiment, the first lid 10 includes first anti-detachment portions 24 for preventing the first elastic body 11 from being detached from the first insertion portion 20. The first anti-detachment portions 24 each have a plate shape. The first anti-detachment portions 24 are provided on the first insertion portion 20 of the first lid 10. Specifically, the first anti-detachment portions 24 are fixed to opposite end portions of the first insertion portion 20 in the width direction of the case main body 9. The first anti-detachment portions 24 are fixed to the first insertion portion 20 with screws or the like. The first anti-detachment portions 24 provided on the first insertion portion 20 each have its plate surface facing in the axial direction of the case main body 9. The first anti-detachment portions 24 provided on the first insertion portion 20 extend outward from the first insertion portion 20. Therefore, the first elastic body 11 externally fitted on the first insertion portion 20 is partially positioned between the first lid main body 19 and the first anti-detachment portions 24. This configuration makes it possible to prevent the first elastic body 11 from being detached from the first insertion portion 20.

In the present embodiment, the second lid 12 includes second anti-detachment portions (not shown) for preventing the second elastic body 13 from being detached from the second insertion portion. The second anti-detachment portions have basically the same configuration as the first anti-detachment portions 24, and are provided on the second insertion portion in the same manner as the first anti-detachment portions 24. Specifically, the plate-shaped second anti-detachment portions are fixed to opposite end portions of the second insertion portion in the width direction of the case main body 9. Therefore, the second elastic body 13 externally fitted on the second insertion portion is partially positioned between the second lid main body 22 and the second anti-detachment portions. This configuration makes it possible to prevent the second elastic body 13 from being detached from the second insertion portion.

When a single-phase alternating current or a three-phase alternating current is applied as electric power to the coil 5 of the encased armature 1 having the above-described configuration, an attractive force and a repulsive force act between a shifting magnetic field generated in the coil 5 and the magnetic field of the magnet plate, whereby thrust is applied to the encased armature 1. As a result, the encased armature 1 can linearly move along in a direction in which a plurality of permanent magnets are arranged on the magnet plate. In this way, the linear motor including the encased armature 1 and the magnet plate operates.

Next, assembly of the encased armature 1 of the present embodiment will be described. The encased armature 1 can be suitably assembled by attaching the first lid 10 and the second lid 12 to the case main body 9 having the armature 2 housed therein. When the second lid 12 is attached to the case main body 9, the inlet 7 and the outlet 8 of the refrigerant pipe 6 are exposed to the outside of the case 3 through the through holes 23 of the second lid 12. Alternatively, after the armature 2 is housed in the case main body 9 having one of the first lid 10 and the second lid 12 attached thereto, the other of the first lid 10 and the second lid 12 may be attached to the case main body 9.

After the armature 2 is housed in the case 3 in the above-described manner, a molten resin is injected into the case 3 through the injection port 21. Following the injection into the case 3, the molten resin is cured to form the resin portion that covers the core 4, the coil 5, and the refrigerant pipe 6. In this way, the armature 2 housed in the case 3 and having the resin portion covering the core 4 and the coil 5 is obtained.

In the instance of the encased armature 1 according to the first embodiment, the first lid 10 is attached to the case main body 9 by the first elastic body 11, and the second lid 12 is attached to the case main body 9 by the second elastic body 13. Therefore, according to the encased armature 1 of the first embodiment, the case 3 is assembled without welding.

In the instance of the encased armature 1 according to the first embodiment, the first elastic body 11 and the second elastic body 13 are O-rings. Therefore, according to the encased armature 1 of the first embodiment, the first lid 10 and the second lid 12 can be easily attached to the case main body 9.

In the instance of the encased armature 1 according to the first embodiment, the case 3 has the injection port 21 for the molten resin. Therefore, the resin portion covering the core 4 and the coil 5 can be formed after the core 4 provided with the coil 5 is housed in the case 3.

In the instance of the encased armature 1 according to the first embodiment, the molten resin is injected into the case 3 through the injection port 21. After the injection into the case 3, the molten resin is cured, and the cured resin can sandwich the first anti-detachment portions 24 and the second anti-detachment portions. Therefore, according to the encased armature 1 of the first embodiment, the first lid 10 and the second lid 12 can be fixed to the case main body 9 with the resin. In other words, the resin functions as a fixing member that fixes the first lid 10 and the second lid 12 to the case main body 9. The fixing member is not limited to the resin, and may be, for example, an adhesive. In this way, the case main body 9 and the first lid 10, and the case main body 9 and the second lid 12 can be fixed by the fixing member.

Next, an encased armature 1a according to a second embodiment of the present invention will be described with reference to FIG. 4. Components denoted by the same reference numerals as those used in the first embodiment have the same functions as in the first embodiment, and a description of such components may be omitted below.

In the first embodiment, the resin portion covering the core 4 and the coil 5 is formed by injecting the resin into the case 3 through the injection port 21, but in the second embodiment, a core 4 and a coil 5 are covered with a resin portion 25 in advance. In this instance, the encased armature 1a can be suitably assembled by attaching a first lid 10 and a second lid 12 to a case main body 9 after an armature 2 including the core 4 and the coil 5 covered with the resin portion 25 is housed in the case main body 9. In the second embodiment, the first anti-detachment portions 24 and the second anti-detachment portions may be omitted.

In the instance of the encased armature 1a according to the second embodiment, the core 4 and the coil 5 are covered with the resin portion 25 before being housed in the case 3.

Therefore, according to the encased armature 1a of the second embodiment, the armature 2 including the core 4 and the coil 5 covered with the resin portion 25 can be easily housed in the case 3.

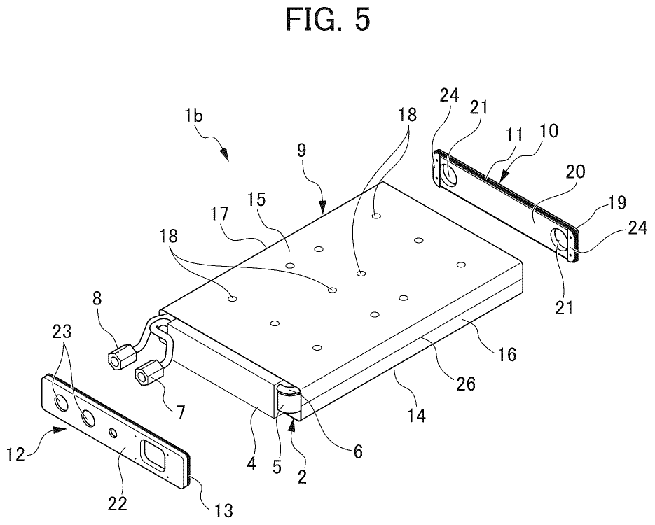

Next, an encased armature 1b according to a third embodiment of the present invention will be described with reference to FIG. 5. Components denoted by the same reference numerals as those used in the first embodiment have the same functions as in the first embodiment, and a description of such components may be omitted below. The encased armature 1b of the third embodiment differs from that of the first embodiment in the configuration of the case 3.

The encased armature 1b according to the third embodiment includes a case main body 9 that has, before being formed into a tubular shape, a third wall 16 divided along a line along the axial direction of the case main body 9 so that a part of the case main body 9 in the circumferential direction can be opened. The case main body 9 is formed into a tubular shape by welding end surfaces of the divisions of the third wall 16 in a state of abutting against each other. That is, the third wall 16 has a welded portion 26 formed by welding the end surfaces of the divisions obtained by dividing the third wall 16 along a plane containing the axis of the case main body 9 as a boundary.

In the third embodiment, the third wall 16 is divided, but the fourth wall 17 may be divided instead of the third wall 16. In this case, the fourth wall 17 has a welded portion 26 formed by welding end surfaces of the divisions obtained by dividing the fourth wall 17 along a plane containing the axis of the case main body 9 as a boundary.

In the instance of the encased armature 1b according to the third embodiment, the welded portion 26 is provided on the third wall 16 or the fourth wall 17. According to the known art, the welded portions are respectively provided at the corner portion between the first wall and the third wall, the corner portion between the first wall and the fourth wall, the corner portion between the second wall and the third wall, and the corner portion between the second wall and the fourth wall. As such, there is a concern that the flatness of the second wall that is attached to a machine and the flatness of the first wall that faces the magnet plate cannot be ensured due to the swells of the welded portions. In contrast, the third embodiment, in which the welded portion is not located at the corner portions of the case main body 9, is free from above-described problem.

In the instance of the encased armature 1b according to the third embodiment, the armature 2 is housed in the case 3 after the case main body 9 is formed into a tubular shape. That is, in the third embodiment, since the welding operation is performed in a state in which the case 3 does not yet have the armature 2 housed therein, the armature 2 is not adversely affected by heat.

In the instance of the encased armature 1b according to the third embodiment, the case main body 9 has the welded portion 26. Therefore, according to the encased armature 1b of the third embodiment, the tubular case main body 9 can be more easily formed as compared with a case where the case main body 9 is formed by extrusion molding.

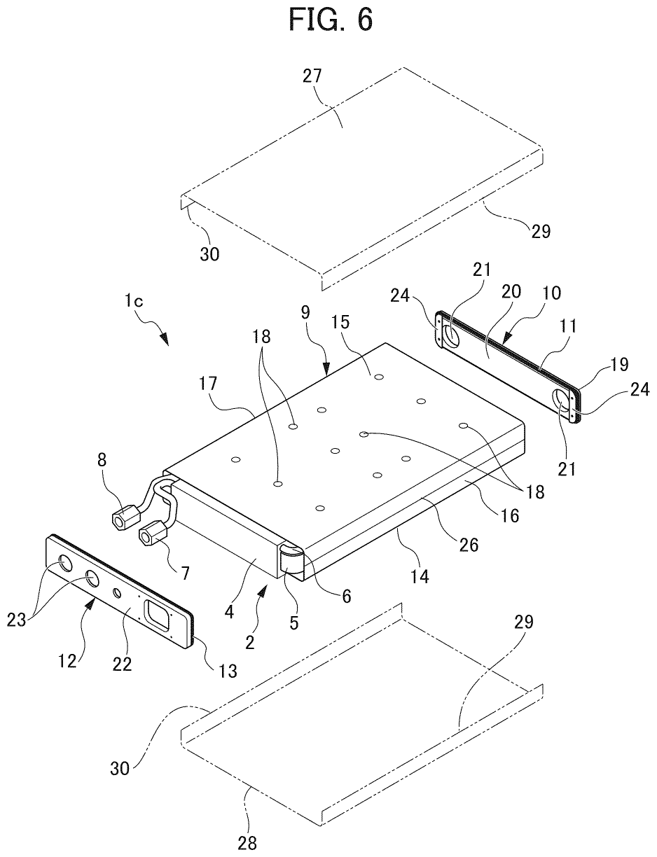

Next, an encased armature 1c according to a fourth embodiment of the present invention will be described with reference to FIG. 6. Components denoted by the same reference numerals as those used in the first embodiment have the same functions as in the first embodiment, and a description of such components may be omitted below. The encased armature 1c of the fourth embodiment differs from that of the first embodiment in the configuration of the case 3.

The encased armature 1c according to the fourth embodiment includes a case main body 9 that has, before being formed into a tubular shape, a third wall 16 and a fourth wall 17 each divided along a line along the axial direction of the case main body 9. As illustrated in FIG. 6, the case main body 9 includes a first member 27 that covers one side of an armature 2 in the thickness direction, and a second member 28 that covers the other side of the armature 2 in the thickness direction. The case main body 9 is formed into a tubular shape by welding end surfaces 29, 29 of the divisions of third wall 16 in a state of abutting against each other and welding end surfaces 30, 30 of the divisions of the fourth wall 17 in a state of abutting against each other. That is, the third wall 16 and the fourth wall 17 each have a welded portion 26 formed by welding the end surfaces of divisions obtained by dividing the respective wall along a plane containing the axis of the case main body 9 as a boundary.

In the instance of the encased armature lc according to the fourth embodiment, the welded portion 26 is provided on each of the third wall 16 and the fourth wall 17. Therefore, the encased armature 1c of the fourth embodiment, in which the welded portion 26 is not located at the corner portions of the case main body 9, the flatness of the first wall 14 and the second wall 15 can be ensured.

In the instance of the encased armature lc according to the fourth embodiment, the armature 2 is housed in the case 3 after the case main body 9 is formed into a tubular shape. That is, in the fourth embodiment, since the welding operation is performed in a state in which the case 3 does not yet have the armature 2 housed therein, the armature 2 is not adversely affected by heat.

In the instance of the encased armature 1c according to the fourth embodiment, the case main body 9 has the welded portions 26. Therefore, according to the encased armature 1c of the fourth embodiment, the tubular case main body 9 can be more easily formed as compared with a case where the case main body 9 is formed by extrusion molding.

According to at least one of the embodiments described above, the encased armature 1 includes the case 3 having the above-described configuration. Thus, it is possible to provide the encased armature 1 with the case 3 having a reduced number of welded portions.

While the present disclosure has been described in detail in the foregoing, it should be noted that the present disclosure is not limited to the individual embodiments described above. Various additions, substitutions, modifications, partial deletions, and the like can be made to the above-described embodiments without departing from the spirit of the present disclosure or the spirit of the present disclosure derived from the claims and the equivalents thereof. The above-described embodiments can also be implemented in combination. For example, in the above-described embodiments, the order of operations and the order of processes are described as an example, and are not intended to limit the present disclosure. The same applies to the case where the above embodiments are described using numerical values or numerical expressions.

For example, in the third and fourth embodiments, the resin portion covering the core 4 and the coil 5 is formed by injecting the molten resin into the case 3 through the injection port 21, but in the third and fourth embodiments, the core 4 and the coil 5 may be covered with the resin portion before the core 4 and the coil 5 are housed in the case 3.

The following further discloses additional remarks regarding the foregoing embodiments.

### Additional Remark 1

An encased armature (1) includes: an armature (2) having a core (4) as a main body, a coil (5) provided to the core (4), a resin portion partially or fully covering the core (4) and the coil (5); and a case (3) capable of housing the armature (2) therein. The case (3) includes a case main body (9) that has a tubular shape and covers an outer side of the armature (2), a first lid (10) that closes an opening at one axial end of the case main body (9), a first elastic body (11) that seals a gap between the case main body (9) and the first lid (10) and allows the first lid (10) to be attached to the case main body (9), a second lid (12) that closes an opening at the other axial end of the case main body (9), and a second elastic body (13) that seals a gap between the case main body (9) and the second lid (12) and allows the second lid (12) to be attached to the case main body (9).

### Additional Remark 2

In the encased armature (1) according to Additional Remark 1, it is preferable that the case main body (9) has a prismatic tubular shape with an R-shaped corner portion. It is preferable that the first lid (10) has a first insertion portion (20) that is insertable into the opening at the one axial end of the case main body (9), and the second lid (12) has a second insertion portion that is insertable into the opening at the other axial end of the case main body (9). It is preferable that the first elastic body (11) and the second elastic body (13) are each an elastically deformable annular member, the first elastic body (11) is externally fitted on the first insertion portion (20), and the second elastic body (13) is externally fitted on the second insertion portion.

### Additional Remark 3

In the encased armature (1) according to Additional Remark 1 or 2, it is preferable that one of the first lid (10) and the second lid (12) has an injection port (21) through which a resin for forming the resin portion is injected into the case (3).

### Additional Remark 4

In the encased armature (1) according to any one of Additional Remarks 1 to 3, it is preferable that the case main body (9) and the first lid (10) are fixed to each other by a fixing member, and the case main body (9) and the second lid (12) are fixed to each other by a fixing member.

### Additional Remark 5

In the encased armature (1) according to any one of Additional Remarks 1 to 4, it is preferable that the case main body (9) has a prismatic tubular shape and includes a first wall (14) facing a magnet plate used as a field magnetic pole of a linear motor, a second wall (15) facing the first wall (14), a third wall (16) connecting one end of the first wall (14) to one end of the second wall (15), and a fourth wall (17) connecting the other end of the first wall (14) to the other end of the second wall (15). It is preferable that one or both of the third wall (16) and the fourth wall (17) have a welded portion (26) formed by welding end surfaces of divisions obtained by dividing one or both of the third wall (16) and the fourth wall (17) along a plane containing the axis of the case main body (9) as a boundary.

### EXPLANATION OF REFERENCE NUMERALS

1: Encased armature
2: Armature
3: Case
4: Core
5: Coil
9: Case main body
10: First lid
11: First elastic body
12: Second lid
13: Second elastic body
14: First wall
15: Second wall
16: Third wall
17: Fourth wall
20: First insertion portion
21: Injection port
25: Resin portion
26: Welded portion

1. An encased armature comprising:
an armature including a core as a main body, a coil provided to the core, a resin portion partially or fully covering the core and the coil; and
a case capable of housing the armature therein,
the case comprising
a case main body that has a tubular shape and covers an outer side of the armature,
a first lid that closes an opening at one axial end of the case main body,
a first elastic body that seals a gap between the case main body and the first lid and allows the first lid to be attached to the case main body,
a second lid that closes an opening at an other axial end of the case main body, and
a second elastic body that seals a gap between the case main body and the second lid and allows the second lid to be attached to the case main body.

2. The encased armature according to claim 1, wherein
the case main body has a prismatic tubular shape with an R-shaped corner portion,
the first lid has a first insertion portion that is insertable into the opening at the one axial end of the case main body,
the second lid has a second insertion portion that is insertable into the opening at the other axial end of the case main body,
the first elastic body and the second elastic body are each an elastically deformable annular member,
the first elastic body is externally fitted on the first insertion portion, and
the second elastic body is externally fitted on the second insertion portion.

3. The encased armature according to claim 1, wherein
one of the first lid and the second lid has an injection port through which a resin for forming the resin portion is injected into the case.

4. The encased armature according to claim 1, wherein
the case main body and the first lid are fixed to each other by a fixing member, and the case main body and the second lid are fixed to each other by a fixing member.

5. The encased armature according to claim 1, wherein
the case main body has a prismatic tubular shape and includes a first wall facing a magnet plate used as a field magnetic pole of a linear motor, a second wall facing the first wall, a third wall connecting one end of the first wall to one end of the second wall, and a fourth wall connecting an other end of the first wall to an other end of the second wall, and
one or both of the third wall and the fourth wall have a welded portion formed by welding end surfaces of divisions obtained by dividing one or both of the third wall and the fourth wall along a plane containing an axis of the case main body as a boundary.
